(19) United States
(12) Patent Application Publication
(10) Pub. No.: US 2026/0369670 A1
(43) Pub. Date: Nov. 19, 2026

(54) Solid-State Electrolyte Membrane and Preparation Method Thereof

(71) Applicant: Microvast, Inc., Stafford, TX (US)

(72) Inventors: Haojun QI, Huzhou (CN); Yan SUN, Huzhou (CN); Weifeng FANG, Huzhou (CN); Wenjuan Liu MATTIS, Stafford, TX (US)

(73) Assignee: Microvast, Inc., Stafford, TX (US)

(21) Appl. No.: 19/210,067

(22) Filed: May 16, 2025

(51) Int. Cl. H01M 10/0562

(52) U.S. Cl. CPC H01M 10/0562; H01M 2300/0077; H01M 2300/008

(57) ABSTRACT

Provided in the present disclosure are solid-state electrolyte membrane and preparation method thereof. The solid-state electrolyte membrane includes a first solid-state electrolyte layer, a high molecular polymer layer, and a second solid-state electrolyte layer, which are sequentially stacked in a thickness direction of the solid-state electrolyte membrane. At least a portion of high molecular polymer in the high molecular polymer layer is filled in the first solid-state electrolyte layer and/or the second solid-state electrolyte layer. In an aspect, the impedance of an interface of “first solid-state electrolyte layer—high molecular polymer layer—second solid-state electrolyte layer” is significantly reduced. In another aspect, the rational design of the high molecular polymer layer also facilitates improvement of the charging and discharging performance of a battery. Therefore, a solid-state battery has excellent interface compatibility, mechanical strength, capacity, energy density, charging and discharging performance, and cycle life.

### TECHNICAL FIELD

The present disclosure relates to the technical field of solid-state electrolyte membranes, and specifically, to solid-state electrolyte membrane and preparation method thereof.

### BACKGROUND

A solid-state electrolyte membrane is a key component of a solid-state battery, which can provide an ion transmission channel between cathode and anode and maintain electronic insulation to prevent the cathode and anode from contacting with each other to cause a short circuit, has an important impact on the safety and electrochemical performance of the battery, and plays an important role in maintaining the stable operation of an energy storage system for a long period of time.

However, a high molecular polymer base membrane needs to be added as a support structure during the preparation of the solid-state electrolyte membrane, so as to ensure a stable structure of the solid-state electrolyte membrane during preparation. However, the solid-state electrolyte membrane prepared by introducing the high molecular polymer base membrane has high interface impedance between base membrane of high molecular polymer and solid-state electrolyte, seriously affecting the safety and electrochemical performance of the solid-state battery, thus not facilitating the long-term operation of the solid-state battery.

Therefore, the interface impedance between base membrane of high molecular polymer and solid-state electrolyte needs to be reduced to form a good high molecular polymer and solid-state electrolyte compatibility interface to reduce the interface impedance, thereby improving the safety and capacity of the solid-state battery.

### SUMMARY

The present disclosure is mainly intended to provide solid-state electrolyte membrane and preparation method thereof, so as to solve the problems of poor safety and poor electrical performance such as capacity and the like of a solid-state battery caused by high interface impedance between base membrane of high molecular polymer and solid-state electrolyte in the related art.

In order to implement the above objective, an aspect of the present disclosure provides a solid-state electrolyte membrane. The solid-state electrolyte membrane includes a first solid-state electrolyte layer, a high molecular polymer layer, and a second solid-state electrolyte layer, which are sequentially stacked in a thickness direction of the solid-state electrolyte membrane. At least a portion of high molecular polymer in the high molecular polymer layer is filled in the first solid-state electrolyte layer and/or the second solid-state electrolyte layer.

As an implementation, 30 wt. %-99 wt. % of the high molecular polymer of the above high molecular polymer layer is filled in the first solid-state electrolyte layer and/or the second solid-state electrolyte layer, or 40 wt. %-99 wt. % of the high molecular polymer of the above high molecular polymer layer is filled in the first solid-state electrolyte layer and/or the second solid-state electrolyte layer, or 60 wt. %-99 wt. % of the high molecular polymer of the above high molecular polymer layer is filled in the first solid-state electrolyte layer and/or the second solid-state electrolyte layer.

As an implementation, when the above high molecular polymer is filled in the first solid-state electrolyte layer and the second solid-state electrolyte layer at the same time, a mass ratio of the high molecular polymer filled in the first solid-state electrolyte layer to the high molecular polymer filled in the second solid-state electrolyte layer is 1-99:99-1.

As an implementation, mechanical strength of the above solid-state electrolyte membrane is 8 MPa-35 MPa; and/or ionic conductivity of the solid-state electrolyte membrane is 0.5×10⁻⁵ S/cm-9.0×10⁻³ S/cm; and/or impedance of the solid-state electrolyte membrane is 15Ω-1200Ω.

As an implementation, a melting point of a first solid-state electrolyte in the above first solid-state electrolyte layer and a melting point of a second solid-state electrolyte in the second solid-state electrolyte layer both are higher than a melting point of the high molecular polymer layer.

As an implementation, a melting point of the above high molecular polymer layer is 80 °C-600 °C, or 120 °C-150 °C.

As an implementation, a thickness of the above solid-state electrolyte membrane is 20 μm-60 μm.

As an implementation, the above high molecular polymer is derived from any one or more of a polyethylene base membrane, a polypropylene base membrane, a polyvinyl chloride base membrane, a polystyrene base membrane, a polyoxymethylene base membrane, a polycarbonate base membrane, a polyamide base membrane, a polyacrylic acid copolymer base membrane, a polysulfone base membrane, a polyphenyl ether base membrane, a polyetherchloride base membrane, and an aramid base membrane.

As an implementation, a melting point of the above first solid-state electrolyte layer is 300 °C-1300 °C, or 300 °C-500 °C.

As an implementation, a thickness of the above first solid-state electrolyte layer is 10 μm-60 μm, or 10 μm-40 μm.

As an implementation, a first solid-state electrolyte in the above first solid-state electrolyte layer and a second solid-state electrolyte in the second solid-state electrolyte layer are each independently selected from any one or more of a sulfide solid-state electrolyte, an oxide solid-state electrolyte, and a polymer solid-state electrolyte.

As an implementation, a thickness of the above high molecular polymer layer is 1 μm-14 μm, or 3 μm-6 μm.

As an implementation, the above first solid-state electrolyte and the second solid-state electrolyte are each independently selected from any one or more of Li_{0.33}La_{0.56}TiO₃, Li_{6.25}Al_{0.25}La₃Zr₂O₁₂, Li₁₀GeP₂S₁₂, Li₂S, Li₃PS₄, Li₂P₃S₁₁, Li₆PS₅Cl, ZrO₂, Li₇La₃Zr₂O₁₂, Li_{1.3}Al_{0.3}Ti_{1.7}(PO₄)₃, LLTO, and a PEEK-LLZO composite material.

As an implementation, a melting point of the above second solid-state electrolyte layer is 300 °C-1300 °C, or 300 °C-500 °C.

As an implementation, a thickness of the above second solid-state electrolyte layer is 10 μm-60 μm, or 10 μm-40 μm.

An aspect of the present disclosure provides a method for preparing the above solid-state electrolyte membrane. The preparation method includes: at S1, a first solid-state electrolyte, a first binder, and a first solvent are mixed to obtain a first slurry; and a second solid-state electrolyte, a second binder, and a second solvent are mixed to obtain a second slurry; at S2, the first slurry and the second slurry are respectively coated on two opposite surfaces in a thickness direction of a high molecular polymer base membrane, so as to obtain a wet membrane; and; and at S3: a heat treatment is performed on the wet membrane to obtain a solid-state electrolyte membrane. The heat treatment includes heat pressing, and a heat pressing temperature is higher than a melting-point temperature of the high molecular polymer base membrane, and is lower than a melting-point temperature of the first solid-state electrolyte and a melting-point temperature of the second solid-state electrolyte.

As an implementation, the high molecular polymer base membrane in S2 contains a through hole structure, and the through hole structure may be formed through penetration of heated rolling needles. A pore diameter of a single through hole is 25 μm-300 μm, or 50 μm-80 μm; and a gap between the adjacent through holes is 10 μm-300 μm, or 40 μm-70 μm.

As an implementation, a mass ratio of the above first solid-state electrolyte to the first binder is (4:1)-(49:1), and/or a mass ratio of the first solid-state electrolyte to the first solvent is (1:9)-(4:6).

As an implementation, a mass ratio of the above second solid-state electrolyte to the second binder is (49:1)-(4:1), and/or a mass ratio of the second solid-state electrolyte to the second solvent is (1:9)-(4:6).

As an implementation, the above first binder and the second binder are each independently selected from any one or more of poly(vinyl alcohol), poly(tetrafluoroethylene), sodium carboxymethyl cellulose, polyolefine, styrene butadiene rubber, fluorinated rubber, polyurethane, poly(tetrafluoroethylene), polyvinylidene fluoride, and polyethylene oxide; and/or the first solvent and the second solvent each independently selected from any one or more of N-methyl-2-pyrrolidone, toluene, xylene, acetonitrile, chloroform, tetrahydrofuran, water, butyl butyrate, ethylene carbonate, diethyl carbonate, dimethyl carbonate, and ethyl methyl carbonate.

As an implementation, the process of the above heat treatment is to dry the wet membrane first and then perform heat pressing.

As an implementation, a drying temperature is 60 °C-100 °C, and a drying time is 6 h-36 h; and/or the heat pressing temperature is 80 °C-600 °C, a heat pressing pressure is 1 MPa-30 MPa, and a heat pressing time is 1 min-120 min.

As an implementation, average particle sizes of the first solid-state electrolyte in the above first solid-state electrolyte layer and the second solid-state electrolyte in the second solid-state electrolyte layer are each independently 500 nm-20 μm.

As an implementation, the above mixing operation in S1 further includes: first stirring is performed; and the mixing operation in S2 further includes second stirring. Rotary speeds of first stirring and second stirring are each independently 1000 r/min-1800 r/min, and the time for first stirring and second stirring is independently 0.2 h-1 h, respectively.

By using the technical solutions of the present disclosure, in the technical solutions of the present disclosure, in an aspect, the high molecular polymer in at least the portion of the high molecular polymer layer in the solid-state electrolyte membrane is filled in the first solid-state electrolyte layer and/or the second solid-state electrolyte layer. Such structure can effectively reduce physical isolation of a base membrane (high molecular polymer layer)-solid-state electrolyte interface, promote smooth transmission of ions, and therefore, significantly reduce the impedance of an interface of “first solid-state electrolyte layer—high molecular polymer layer—second solid-state electrolyte layer”. Low interface impedance means that a charge carrier can move between cathode and anode more efficiently, thereby improving the overall electrochemical performance such as cycling stability and the like of a battery. In another aspect, since low interface impedance allows a faster ion transmission speed, the rational design of the high molecular polymer layer also facilitates improvement of the charging and discharging performance of the battery. In combination with the above two aspects, in the present disclosure, through the unique structure design of the solid-state electrolyte membrane, the solid-state electrolyte membrane of the present disclosure has a good external shape, and causes the solid-state battery to have excellent interface compatibility, mechanical strength, capacity, energy density, charging and discharging performance, and cycle life.

### BRIEF DESCRIPTION OF THE DRAWINGS

The drawings, which form a part of the present disclosure, are used to provide a further understanding of the present disclosure. The exemplary embodiments of the present disclosure and the description thereof are used to explain the present disclosure, but do not constitute improper limitations to the present disclosure. In the drawings:

FIG. 1(a) is an Electrochemical Impedance Spectroscopy (EIS) diagram of a solid-state battery corresponding to a solid-state electrolyte membrane before heat pressing according to Comparative embodiment 1 of the present disclosure.

FIG. 1(b) is an EIS diagram of a solid-state battery corresponding to a solid-state electrolyte membrane after heat pressing according to Embodiment 1 of the present disclosure.

FIG. 2 is a test diagram of cycling performance of a full battery using a solid-state electrolyte membrane shown in Embodiment 1 of the present disclosure.

### DETAILED DESCRIPTION OF THE EMBODIMENTS

It is to be noted that the embodiments in the present disclosure and the features in the embodiments may be combined with one another without conflict. The present disclosure will be described below in detail with reference to the drawings and the embodiments.

As analyzed in the Background of the present disclosure, there are problems of poor safety and poor electrical performance such as capacity and the like of a solid-state battery caused by high interface impedance of a base membrane-solid-state electrolyte interface in the related art. In order to solve the above problems, the present disclosure provides solid-state electrolyte membrane and preparation method thereof.

A typical implementation of the present disclosure provides a solid-state electrolyte membrane. The solid-state electrolyte membrane includes a first solid-state electrolyte layer, a high molecular polymer layer, and a second solid-state electrolyte layer, which are sequentially stacked in a thickness direction of the solid-state electrolyte membrane. At least a portion of high molecular polymer in the high molecular polymer layer is filled in the first solid-state electrolyte layer and/or the second solid-state electrolyte layer.

In the technical solutions of the present disclosure, in an aspect, the high molecular polymer in at least the portion of the high molecular polymer layer in the solid-state electrolyte membrane is filled in the first solid-state electrolyte layer and/or the second solid-state electrolyte layer. Such structure can effectively reduce physical isolation of a base membrane (high molecular polymer layer)-solid-state electrolyte interface, promote smooth transmission of ions, and therefore, significantly reduce the impedance of an interface of “first solid-state electrolyte layer—high molecular polymer layer—second solid-state electrolyte layer”. Low interface impedance means that a charge carrier can move between cathode and anode more efficiently, thereby improving the overall electrochemical performance such as cycling stability and the like of a battery. In another aspect, since low interface impedance allows a faster ion transmission speed, the rational design of the high molecular polymer layer also facilitates improvement of the charging and discharging performance of the battery. In combination with the above two aspects, in the present disclosure, through the unique structure design of the solid-state electrolyte membrane, the solid-state electrolyte membrane of the present disclosure has a good external shape, and causes the solid-state battery to have excellent interface compatibility, mechanical strength, capacity, energy density, charging and discharging performance, and cycle life.

In an embodiment of the present disclosure, 30 wt. %-99 wt. % of the high molecular polymer of the above high molecular polymer layer is filled in the first solid-state electrolyte layer and/or the second solid-state electrolyte layer, or 40 wt. %-99 wt. % of the high molecular polymer of the above high molecular polymer layer is filled in the first solid-state electrolyte layer and/or the second solid-state electrolyte layer, or 60 wt. %-99 wt. % of the high molecular polymer of the above high molecular polymer layer is filled in the first solid-state electrolyte layer and/or the second solid-state electrolyte layer.

In an aspect, the high percentage filling of the high molecular polymer in the solid-state electrolyte layer means that a direct contact between the first solid-state electrolyte layer and the second solid-state electrolyte layer is fuller. When a filling amount of the high molecular polymer is increased, the high molecular polymer can be filled in pores of the solid-state electrolyte layer more fully, thereby reducing interface impedance. In another aspect, as a flexible material having an adhesive action, the high proportion filling of the high molecular polymer can improve the overall mechanical strength and toughness of the solid-state electrolyte membrane, facilitating improvement of the breakage resistance of the solid-state battery during manufacturing and use, especially when the battery is folded, bent, or subjected to external impacts. In yet another aspect, the high proportion filling of the high molecular polymer may improve ion transmission of the solid-state electrolyte to a certain extent, because the high molecular polymer may make up discontinuity caused by gaps between solid-state electrolyte particles, thereby forming a more continuous conduction path. Therefore, by controlling a filling ratio of the high molecular polymer within the above range, the interface impedance, mechanical property, ion conductivity, thickness uniformity, energy density, and cycling performance of the solid-state battery may be effectively improved, and the thermal stability and safety of the solid-state battery are improved at the same time.

30 wt. %, 35 wt. %, 40 wt. %, 45 wt. %, 50 wt. %, 55 wt. %, 60 wt. %, 62 wt. %, 65 wt. %, 70 wt. %, 72 wt. %, 75 wt. %, 80 wt. %, 82 wt. %, 85 wt. %, 90 wt. %, 93 wt. %, 95 wt. %, 99 wt. % of the high molecular polymer of the above high molecular polymer layer may be filled in the first solid-state electrolyte layer and/or the second solid-state electrolyte layer. Definitely, any one of point values within 30 wt. %-99 wt. % of the high molecular polymer of the above high molecular polymer layer may be filled in the first solid-state electrolyte layer and/or the second solid-state electrolyte layer, and is not described herein again.

In an embodiment of the present disclosure, when the above high molecular polymer is filled in the first solid-state electrolyte layer and the second solid-state electrolyte layer at the same time, a mass ratio of the high molecular polymer filled in the first solid-state electrolyte layer to the high molecular polymer filled in the second solid-state electrolyte layer is 1-99:99-1.

By controlling the mass ratio of the high molecular polymer filled in the first solid-state electrolyte layer to the high molecular polymer filled in the second solid-state electrolyte layer within the above range, in an aspect, an internal structure of the solid-state electrolyte membrane may be finely adjusted, and the interface impedance between the first solid-state electrolyte layer and the second solid-state electrolyte layer is optimized. In another aspect, since the filling ratio of the high molecular polymer directly affects the ion conductivity of the solid-state electrolyte layer, by controlling the filling ratio at the above mass ratio, the electrochemical performance of a battery under various charging and discharging conditions is improved, including charging and discharging efficiency and cycling stability. In yet another aspect, as a support structure, the distribution of the high molecular polymer layer in the two solid-state electrolyte layers also affects the mechanical property of the solid-state electrolyte membrane. By controlling the above mass ratio, negative effects on the electrochemical performance of the battery are minimized while the battery has excellent mechanical strength and flexibility. An accurate filling ratio may cause the solid-state electrolyte membrane to be less prone to breakage when subjected to an external force, and also reduce the amount of the high molecular polymer impeding an ion conduction path.

The mass ratio of the high molecular polymer filled in the first solid-state electrolyte layer to the high molecular polymer filled in the second solid-state electrolyte layer may be 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:5, 95:5, or 99:1. Definitely, the mass ratio of the high molecular polymer filled in the first solid-state electrolyte layer to the high molecular polymer filled in the second solid-state electrolyte layer may be any one of point values within 1-99:99-1, and is not described herein again.

In an embodiment of the present disclosure, mechanical strength of the above solid-state electrolyte membrane is 8 MPa-35 MPa; and/or ionic conductivity of the solid-state electrolyte membrane is 0.5×10⁻⁵ S/cm-9.0×10⁻³ S/cm; and/or impedance of the solid-state electrolyte membrane is 15Ω-1200Ω.

By controlling the mechanical strength of the solid-state electrolyte membrane within the above range, the durability and reliability of the battery are improved. During the manufacturing, assembly, and use of the battery, even if subjected to external impact or deformation, the solid-state electrolyte membrane can maintain its integrity, and is not easy to rupture or damage. Moreover, the solid-state electrolyte membrane with high mechanical strength is more suitable for automated and continuous production processes, and can bear mechanical stress in a high-speed production environment, such as squeezing, folding, or cutting, without affecting the performance of a membrane material, thereby ensuring the feasibility and efficiency of large-scale production. By controlling the ionic conductivity of the solid-state electrolyte membrane within the above range, lithium ions between cathode and anode are efficiently transmitted, and resistance inside the battery is reduced, thereby improving a charging and discharging rate and efficiency of the battery. Moreover, the stable performance of the battery can also be maintained within a wide temperature range. In particular, in a low-temperature environment, desirable ionic conductivity facilitates the maintaining of a voltage platform of the battery, thereby ensuring the normal starting and operation of the battery. By controlling the impedance of the solid-state electrolyte membrane within the above range, an energy loss of the battery during charging and discharging may be greatly reduced. Low impedance means that the flow of a current inside the battery is smoother, and a voltage drop during charging and discharging is small, thereby improving the overall energy conversion efficiency of the battery. Moreover, the low impedance facilitates improvement of the cycling stability of the battery. As the number of cycles of the battery increases, changes in the impedance affect the coulombic efficiency and capacity retention rate of the battery. By controlling the impedance within the above range, the cycle life of the battery may be prolonged, and performance degradation is reduced.

In some embodiments of the present disclosure, the mechanical strength of the above solid-state electrolyte membrane is 10 MPa-35 MPa. Specifically, the mechanical strength of the above solid-state electrolyte membrane may be 8 MPa, 10 MPa, 12 MPa, 13 MPa, 15 MPa, 17 MPa, 18 MPa, 19 MPa, 20 MPa, 21 MPa, 23 MPa, 24 MPa, 25 MPa, 27 MPa, 28 MPa, 30 MPa, 32 MPa, or 35 MPa, and may definitely be any value within 8 MPa-35 MPa, and is not described herein again.

In some embodiments of the present disclosure, the ionic conductivity of the above solid-state electrolyte membrane is 6.0×10⁻⁴ S/cm-1.8×10⁻³ S/cm. Specifically, the ionic conductivity of the above solid-state electrolyte membrane may be 0.5×10⁻⁵ S/cm, 1.0×10⁻⁵ S/cm, 2.5×10⁻⁵ S/cm, 5×10⁻⁵ S/cm, 1.0×10⁻⁴ S/cm, 2.5×10⁻⁴ S/cm, 5.0×10⁻⁴ S/cm, 5.43×10⁻⁴ S/cm, 5.89×10⁻⁴ S/cm, 6.0×10⁻⁴ S/cm, 6.17×10⁻⁴ S/cm, 6.34×10⁻⁴ S/cm, 6.52×10⁻⁴ S/cm, 6.5×10⁻⁴ S/cm, 7.0×10⁻⁴ S/cm, 7.14×10⁻⁴ S/cm, 7.5×10⁻⁴ S/cm, 7.68×10⁻⁴ S/cm, 7.95×10⁻⁴ S/cm, 7.98×10⁻⁴ S/cm, 8.0×10⁻⁴ S/cm, 9.0×10⁻⁴ S/cm, 1.0×10⁻³ S/cm, 1.1×10⁻³ S/cm, 1.22×10⁻³ S/cm, 1.13×10⁻³ S/cm, 1.3×10⁻³ S/cm, 1.32×10⁻³ S/cm, 1.5×10⁻³ S/cm, 1.51×10⁻³ S/cm, 1.8×10⁻³ S/cm, 1.85×10⁻³ S/cm, 2.5×10⁻³ S/cm, 5.0×10⁻³ S/cm, or 9.0×10⁻³ S/cm, and may definitely be any value within 0.5×10⁻⁵ S/cm-9.0×10⁻³ S/cm, and is not described herein again.

In some embodiments of the present disclosure, the impedance of the above solid-state electrolyte membrane is 15Ω-1200Ω, or the impedance of the above solid-state electrolyte membrane is 50Ω-1000Ω, or the impedance of the above solid-state electrolyte membrane is 50Ω-600Ω, or the impedance of the above solid-state electrolyte membrane is 100Ω-500Ω. Further, the impedance of the solid-state electrolyte membrane may be 15Ω, 20Ω, 50Ω, 56Ω, 80Ω, 86Ω, 94Ω, 100Ω, 111Ω, 116Ω, 120Ω, 133Ω, 150Ω, 200Ω, 202Ω, 223Ω, 242 Ω, 250Ω, 300Ω, 350Ω, 380Ω, 400Ω, 435Ω, 450Ω, 475Ω, 497Ω, 500Ω, 550Ω, 600Ω, 650Ω, 700Ω, 750Ω, 800Ω, 850Ω, 900Ω, 950Ω, 1000Ω, 1050Ω, 1100Ω, 1150Ω, or 1200Ω, and may definitely be any one of point values within 15Ω-1200Ω, and is not described herein again.

In an embodiment of the present disclosure, a melting point of the first solid-state electrolyte in the above first solid-state electrolyte layer and a melting point of the second solid-state electrolyte in the second solid-state electrolyte layer both are higher than a melting point of the high molecular polymer.

In an aspect, due to the low melting point of the high molecular polymer, the high molecular polymer melts and is filled in the first solid-state electrolyte layer and/or the second solid-state electrolyte layer at a specific temperature, while the solid-state electrolyte layers maintain their structural integrity and stability due to its high melting point. In this way, the filling of the high molecular polymer in the high molecular polymer layer in the first solid-state electrolyte layer and/or the second solid-state electrolyte layer can promote a closer contact between the first solid-state electrolyte layer and the second solid-state electrolyte layer, thereby significantly reducing interface impedance, and improving the transmission efficiency of the lithium ions and the charging and discharging performance of the battery. In another aspect, the first solid-state electrolyte layer and the second solid-state electrolyte layer have high melting points, such that the battery can better maintain its shape and function in a high-temperature operation environment, and structural failure or performance degradation are not easy to occur. Such thermal stability is crucial for improvement of safety and service life of the battery under extreme conditions.

In an embodiment of the present disclosure, the melting point of the above high molecular polymer is 80 °C-600 °C, or 120 °C-150 °C.

By controlling the melting point of the above high molecular polymer within the above range, in an aspect, during the heat pressing process, at least a portion of the high molecular polymer in the high molecular polymer layer may be filled in the solid-state electrolyte layer, without resulting in melting or deformation of the solid-state electrolyte layer. Such accurate temperature control facilitates the realizing of a good interlayer contact, reduction in interface impedance, and the maintaining of the structure stability and electrochemical performance of the solid-state electrolyte membrane at the same time. In another aspect, the high molecular polymer layer can be softened and melted at a low temperature, which not only facilitates the improvement of the mechanical property of the solid-state electrolyte membrane, such as flexibility and strength, but also facilitates the improvement of the processability in continuous production. In yet another aspect, by selecting the above range, interface compatibility among the first solid-state electrolyte layer—the high molecular polymer layer—the second solid-state electrolyte layer is effectively promoted without damaging the solid-state electrolyte layer, such that interface impedance is reduced, thereby improving the electrochemical performance and long-term stability of the battery.

The melting point of the above high molecular polymer may be 80 °C, 90 °C, 100 °C, 110 °C, 120 °C, 130 °C, 140 °C, 150 °C, 160 °C, 170 °C, 180 °C, 190 °C, 200 °C, 210 °C, 220 °C, 230 °C, 320 °C, 430 °C, 520 °C, 550 °C, or 600 °C. Definitely, the melting point of the above high molecular polymer may also be any one of point values within 80 °C-600 °C, and is not described herein again.

In an embodiment of the present disclosure, the thickness of the above solid-state electrolyte membrane is 20 μm-60 μm.

The thickness of the solid-state electrolyte membrane is a sum of the thicknesses of the first solid-state electrolyte layer, high molecular polymer layer, and second solid-state electrolyte layer. The thickness of the solid-state electrolyte membrane is directly related to the mechanical strength and ion transmission efficiency of the solid-state electrolyte membrane. If the solid-state electrolyte membrane is too thick, the impedance of the solid-state electrolyte membrane may be increased, and energy density is reduced; and if the solid-state electrolyte membrane is too thin, the mechanical strength of the solid-state electrolyte membrane may be reduced, resulting in a short circuit in the battery. By controlling the thickness of the solid-state electrolyte membrane within the above range, in an aspect, a migration path of the lithium ions inside the battery may be significantly shortened, thereby reducing internal resistance of the battery. Low internal resistance facilitates improvement of the charging and discharging efficiency of the battery, reduction in energy loss, and improvement of the overall energy density and performance of the battery. In another aspect, a thin solid-state electrolyte membrane facilitates the weakening of polarization of the battery during charging and discharging, such that a low-temperature voltage platform of a lithium ion battery is improved, and the starting capability and energy output efficiency of the battery under a cold condition are improved. Therefore, by controlling the thickness of the solid-state electrolyte membrane within the above range, the performance of the battery in a low-temperature environment is improved. Specifically, the thickness of the solid-state electrolyte membrane is selected to be 20 μm-60 μm. The thickness of the solid-state electrolyte membrane being 30 μm-40 μm facilitates the better realizing of the high energy density of above 287 Wh/kg of the battery (e.g., the high energy density of the battery is 287 Wh/kg-348 Wh/kg), for example, the high energy density of the battery may be 287 Wh/kg, 296 Wh/kg, 305 Wh/kg, 307 Wh/kg, 312 Wh/kg, 316 Wh/kg, 319 Wh/kg, 323 Wh/kg, 324 Wh/kg, 328 Wh/kg, 332 Wh/kg, 345 Wh/kg, 348 Wh/kg, such that continuous production operations during manufacturing are matched more fully, and the mechanical property of the solid-state electrolyte membrane is ensured. Further, the thickness of the solid-state electrolyte membrane may be 20 μm, 25 μm, 30 μm, 32 μm, 35 μm, 38 μm, 40 μm, 42 μm, 45 μm, 50 μm, 55 μm, or 60 μm. Definitely, the thickness of the solid-state electrolyte membrane may be any value within the range of 20 μm-60 μm, and is not described herein again.

In an embodiment of the present disclosure, the above high molecular polymer is derived from any one or more of a polyethylene base membrane, a polypropylene base membrane, a polyvinyl chloride base membrane, a polystyrene base membrane, a polyoxymethylene base membrane, a polycarbonate base membrane, a polyamide base membrane, a polyacrylic acid copolymer base membrane, a polysulfone base membrane, a polyphenyl ether base membrane, a polyetherchloride base membrane, and an aramid base membrane.

Different high molecular polymers can endow different mechanical properties for the solid-state electrolyte membrane due to its unique physical property, such as high toughness, strength, and tear resistance. By controlling the high molecular polymer to drive from the above high molecular polymer base membranes, compatibility and interface integration capability between the high molecular polymer and the high molecular polymer may be optimized. The above types of the high molecular polymer base membranes not only cause the structure of the solid-state electrolyte membrane to be stable and not easy to collapse, but also cause a mechanical arm to be able to directly grasp the solid-state electrolyte membrane, so as to achieve continuous production. Hot melt occurs in the high molecular polymer base membrane during subsequent heat pressing, such that a contact area between the first solid-state electrolyte layer and the second solid-state electrolyte layer located above and below the high molecular polymer base membrane is increased, thereby reducing the interface impedance of the interface of first solid-state electrolyte layer—high molecular polymer layer—second solid-state electrolyte layer.

In an embodiment of the present disclosure, a melting point of the first solid-state electrolyte in the above first solid-state electrolyte layer is 300 °C-1300 °C, or 300 °C-500 °C.

By controlling the melting point of the first solid-state electrolyte within the above range, in an aspect, the first solid-state electrolyte with a high melting point can maintain the stability of the structure and performance of the battery during operation in a high-temperature environment, such that thermal decomposition or structural phase transition do not easy to occur. In another aspect, the solid-state electrolyte with a higher melting point often has lower interface impedance and more excellent electrochemical performance, facilitating the increasing of the energy density of the battery. In yet another aspect, the high melting point of the first solid-state electrolyte is combined with good ionic conductivity, such that a charging and discharging rate of the battery may be optimized, and an energy loss during charging and discharging is reduced, thereby improving the charging and discharging efficiency of the battery. The melting point of the above first solid-state electrolyte layer may be 300 °C, 310 °C, 320 °C, 330 °C, 340 °C, 350 °C, 360 °C, 370 °C, 380 °C, 390 °C, 400 °C, 420 °C, 450 °C, 480 °C, 500 °C, 530 °C, 550 °C, 580 °C, 600 °C, 620 °C, 650 °C, 680 °C, 700 °C, 720 °C, 750 °C, 780 °C, 800 °C, 820 °C, 850 °C, 880 °C, 900 °C, 920 °C, 950 °C, 1050 °C, 1120 °C, 1280 °C, or 1300 °C. Definitely, the melting point of the first solid-state electrolyte layer may also be any value within 300 °C-1300 °C, and is not described herein again.

In an embodiment of the present disclosure, a thickness of the above first solid-state electrolyte layer is 10 μm-60 μm, or 10 μm-40 μm.

By controlling the thickness of the above first solid-state electrolyte layer within the above range, in an aspect, the lithium ions have enough but not too long migration path. Moreover, a thin electrolyte layer can reduce resistance of ion transmission, and a migration speed of the lithium ions between cathode and anode is accelerated, thereby improving the charging and discharging efficiency and power density of the battery. In another aspect, the occupation of the overall size of the battery is relatively rational, such that an active substance ratio in the battery is maximized, thereby increasing the energy density of the battery. In yet another aspect, enough strength may be maintained to prevent an internal short circuit of the battery. Moreover, an appropriate thickness can ensure the stability of the electrolyte layer at a high temperature, and the risk of thermal runaway is reduced, thereby improving the safety of the battery.

The thickness of the first solid-state electrolyte layer may be 10 μm, 12 μm, 15 μm, 18 μm, 20 μm, 22 μm, 25 μm, 28 μm, 30 μm, 32 μm, 38 μm, 40 μm, 45 μm, 50 μm, 55 μm, or 60 μm. Definitely, the thickness of the first solid-state electrolyte layer may be any value within 10 μm-60 μm, and is not described herein again.

In an embodiment of the present disclosure, the thickness of the above high molecular polymer layer is 1 μm-14 μm, or 3 μm-6 μm.

In an aspect, the high molecular polymer layer with the above thickness meets the lightness and thinness of the solid-state electrolyte membrane to reduce the overall weight of the battery, thereby increasing energy density. In another aspect, the high molecular polymer layer with the above thickness plays a role in supporting the solid-state electrolyte membrane, and an enough thickness maintains the mechanical stability of the solid-state electrolyte membrane, thereby reducing the risk of a short circuit in the battery. The thickness of the high molecular polymer layer is 1 μm, 2 μm, 3 μm, 4 μm, 5 μm, 6 μm, 7 μm, 8 μm, 9 μm, 10 μm, 11 μm, 12 μm, 13 μm, or 14 μm. Definitely, the thickness of the base membrane may be any one of point values within 1 μm-14 μm, and is not described herein again.

In an embodiment of the present disclosure, a first solid-state electrolyte in the above first solid-state electrolyte layer and a second solid-state electrolyte in the second solid-state electrolyte layer are each independently selected from any one or more of a sulfide solid-state electrolyte, an oxide solid-state electrolyte, and a polymer solid-state electrolyte.

Different types of the solid-state electrolytes have respective advantages, such as high ionic conductivity, good thermal stability, chemical stability, and mechanical strength. By combining and using different types of the solid-state electrolytes, complementary and optimized performance may be achieved for higher overall performance. For example, the sulfide solid-state electrolyte has high ionic conductivity but may be poor in chemical stability, and the oxide solid-state electrolyte has good chemical stability but is low in ionic conductivity, such that the combination of the sulfide solid-state electrolyte and the oxide solid-state electrolyte can balance these properties to achieve an optimal solution. By flexibly using different combinations of the sulfide solid-state electrolyte, the oxide solid-state electrolyte, and the polymer solid-state electrolyte, the solid-state electrolyte membrane may have a good external shape, and at the same time, the two solid-state electrolyte layers in the solid-state electrolyte membrane are in a closer contact with each other, such that smaller interface impedance is realized. Specifically, optimization may be performed based on different performance requirements of the battery, such that the electrochemical performance is improved, the safety is improved, the interface impedance is reduced, the energy density and cycle life are increased, and the processability is improved at the same time, thereby ensuring that the solid-state battery can meet diversified application requirements.

In an embodiment of the present disclosure, the above first solid-state electrolyte and the second solid-state electrolyte are each independently selected from any one or more of Li_{0.33}La_{0.56}TiO₃, Li_{6.25}Al_{0.25}La₃Zr₂O₁₂, Li₁₀GeP₂S₁₂, Li₂S, Li₃PS₄, Li₂P₃S₁₁, Li₆PS₅Cl, ZrO₂, Li₇La₃Zr₂O₁₂, Li_{1.3}Al_{0.3} Ti_{1.7}(PO₄)₃, LLTO, and a PEEK-LLZO composite material.

The inherent characteristic of a sulfide facilitates formation of a compact layer, and improvement of isolation between electrodes, thereby ensuring the safety and performance consistency of the battery. By selecting the sulfide such as Li₆PS₅Cl, Li₁₀GeP₂S₁₂, etc. as the first solid-state electrolyte or the second solid-state electrolyte, the charging and discharging efficiency and cycle life of the battery are significantly improved because of its high ionic conductivity and chemical stability.

In an embodiment of the present disclosure, a melting point of the second solid-state electrolyte in the above second solid-state electrolyte layer is 300 °C-1300 °C, or 300 °C-500 °C.

The second solid-state electrolyte with the above melting point has a more stable structure at a battery processing temperature, such that the risk of melting and deformation is reduced, complementarity is formed with the low-melting-point high molecular polymer layer at the same time, the mechanical properties of the entire solid-state electrolyte membrane are improved, and high ionic conductivity is maintained, thereby improving the safety and energy density of the battery. The melting point of the above second solid-state electrolyte may be 300 °C, 310 °C, 320 °C, 330 °C, 340 °C, 350 °C, 360 °C, 370 °C, 380 °C, 390 °C, 400 °C, 420 °C, 450 °C, 480 °C, 500 °C, 530 °C, 550 °C, 580 °C, 600 °C, 620 °C, 650 °C, 680 °C, 700 °C, 720 °C, 750 °C, 780 °C, 800 °C, 820 °C, 850 °C, 880 °C, 900 °C, 920 °C, 950 °C, 1050 °C, 1120 °C, 1280 °C, or 1300 °C. Definitely, the melting point of the second solid-state electrolyte may also be any value within 300 °C-1300 °C, and is not described herein again.

In an embodiment of the present disclosure, a thickness of the above second solid-state electrolyte layer is 10 μm-60 μm, or 10 μm-40 μm.

The thickness of the second solid-state electrolyte layer facilitates its synergy with the thickness of the first solid-state electrolyte layer, such that the total thickness of the solid-state electrolyte membrane is controlled within a certain range. Furthermore, a necessary ion conduction channel is provided, good electrochemical performance is maintained, the impedance and thickness of the battery are not increased excessively, energy density and safety are balanced, and thus, the second solid-state electrolyte layer is suitable for high efficiency battery production and application. The thickness of the second solid-state electrolyte layer may be 10 μm, 12 μm, 15 μm, 18 μm, 20 μm, 22 μm, 25 μm, 28 μm, 30 μm, 32 μm, 38 μm, 40 μm, 45 μm, 50 μm, 55 μm, or 60 μm. Definitely, the thickness of the second solid-state electrolyte layer may be any value within 10 μm-60 μm, and is not described herein again.

Another typical implementation of the present disclosure provides a method for preparing the above solid-state electrolyte membrane. The preparation method includes: at S1, a first solid-state electrolyte, a first binder, and a first solvent are mixed to obtain a first slurry; and a second solid-state electrolyte, a second binder, and a second solvent are mixed to obtain a second slurry; at S2, the first slurry and the second slurry are respectively coated on two opposite surfaces in a thickness direction of a high molecular polymer base membrane, so as to obtain a wet membrane; and; and at S3: a heat treatment is performed on the wet membrane to obtain a solid-state electrolyte membrane. The heat treatment includes heat pressing, and a heat pressing temperature is higher than a melting-point temperature of the high molecular polymer base membrane, and is lower than a melting-point temperature of the first solid-state electrolyte and a melting-point temperature of the second solid-state electrolyte.

The key of the method for preparing the above solid-state electrolyte membrane is the controlling of heat treatment conditions. The heat treatment is to dry the wet membrane first and then perform heat pressing. The integrity and performance optimization of the structure of the solid-state electrolyte membrane are ensured by controlling the heat pressing temperature of the heat treatment to be higher than the melting-point temperature of the high molecular polymer layer and controlling the heat pressing temperature of the heat treatment to be lower than the melting-point temperature of the first solid-state electrolyte and the melting-point temperature of the second solid-state electrolyte at the same time. Specifically, through the controlling of the heat pressing temperature, the process of heat pressing can promote hot melt in the high molecular polymer base membrane and cause a portion of the high molecular polymer base membrane to be filled in the first solid-state electrolyte layer and/or the second solid-state electrolyte layer, so as to form a more continuous structure, such that the mechanical strength of the solid-state electrolyte membrane is increased, and solvents introduced during slurry preparation are removed during drying, thereby ensuring the compactness and purity of the solid-state electrolyte membrane. The first solid-state electrolyte layer is in close contact with the second solid-state electrolyte layer, so as to reduce interface impedance between the first solid-state electrolyte layer—the high molecular polymer layer—the second solid-state electrolyte layer.

Furthermore, the heat pressing process can also adjust a microstructure of the solid-state electrolyte membrane, reduce the interface impedance, and improve electrical performance.

As an implementation, the high molecular polymer base membrane in S2 contains a through hole structure, and the through hole structure may be formed through penetration of heated rolling needles. That is, the through hole structure (via hole) may be formed by performing a heated rolling needle penetration operation on a common high molecular polymer base membrane. A size of a penetrated hole is adjusted by adjusting a height of a roller. A punching position is adjusted by adjusting a base plate. A heating temperature is debugged according to specific common materials. Therefore, a pore diameter of a single through hole obtained is 25 μm-300 μm, or 50 μm-80 μm; and a gap between the adjacent through holes is 10 μm-300 μm, or 40 μm-70 μm. Therefore, ion transmission efficiency is improved to a maximum extent.

The above holes increase the porosity of the high molecular polymer base membrane in a physical manner, such that ion migration is promoted, and the mechanical property of the high molecular polymer base membrane is also adjusted at the same time. Specifically, for the solid-state electrolyte membrane obtained by the above preparation method, in an aspect, in the case that the thickness of the solid-state electrolyte membrane is constant, the mechanical strength of the solid-state electrolyte membrane is effectively improved, and a short circuit in a battery caused by punctures is prevented. In another aspect, the first solid-state electrolyte layer can be in direct contact with the second solid-state electrolyte layer through the through hole (via hole) of the high molecular polymer base membrane, causing the contact between the first solid-state electrolyte layer and the second solid-state electrolyte layer to be closer, such that interface impedance is reduced, and lithium ion transmission efficiency is improved. Therefore, through the above plurality of factors, the solid-state electrolyte membrane can take lower impedance and higher energy density into consideration while having excellent mechanical properties.

Specifically, by controlling the pore diameter of the through hole within the above range, the high molecular polymer base membrane has effectively-transmitted lithium ions, and also has a microstructure with enough supporting strength. The through hole with the pore diameter of 50 μm-80 μm further ensures the high efficiency of an ion transmission path, and simultaneously limits the risk of a reduction in mechanical strength caused by excessive pore diameter. The pore diameter of the through hole may be 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 105 μm, 110 μm, 115 μm, 120 μm, 125 μm, 130 μm, 135 μm, 140 μm, 145 μm, 150 μm, 180 μm, 220 μm, 265 μm, 280 μm, or 300 μm. Definitely, the pore diameter of the through hole may be any value within 25 μm-300 μm, and is not described herein again.

A small gap between the adjacent through holes facilitates the increasing of the contact area between the first solid-state electrolyte layer and the second solid-state electrolyte layer, thereby promoting ion conduction, and reducing interface impedance. The gap between the adjacent through holes being 40 μm-70 μm more facilitates formation of a denser lithium ion transmission network, and simultaneously reduces the risk of material crowding and porosity reduction due to a too small gap. The gap between the adjacent through holes may be 10 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 255 μm, or 300 μm. Definitely, the gap between the adjacent through holes may be any value within 10 μm-300 μm, and is not described herein again.

In an embodiment of the present disclosure, a mass ratio of the above first solid-state electrolyte to the first binder is (4:1)-(49:1), and/or a mass ratio of the first solid-state electrolyte to the first solvent is (1:9)-(4:6).

By controlling the mass ratio of the first solid-state electrolyte to the first binder, and the mass ratio of the first solid-state electrolyte to the first solvent within the above ranges, a cooperative interaction effect among the first solid-state electrolyte, the first binder, and the first solvent is achieved, so as to obtain the uniformly-mixed first slurry, such that the first solid-state electrolyte layer formed on the high molecular polymer base membrane is distributed more uniformly, thereby further improving the structure stability of the solid-state electrolyte membrane. Moreover, by selecting the above type of the first solvent, the first solvent is effectively removed during the heat treatment without affecting the structure of the solid-state electrolyte membrane.

In an embodiment of the present disclosure, a mass ratio of the above second solid-state electrolyte to the second binder is (49:1)-(4:1), and/or a mass ratio of the second solid-state electrolyte to the second solvent is (1:9)-(4:6).

By controlling the mass ratio of the second solid-state electrolyte to the second binder, and the mass ratio of the second solid-state electrolyte to the second solvent within the above ranges, a cooperative interaction effect among the second solid-state electrolyte, the second binder, and the second solvent is achieved, so as to obtain the uniformly-mixed second slurry, such that the second solid-state electrolyte layer formed on the high molecular polymer base membrane is distributed more uniformly, thereby further improving the structure stability of the solid-state electrolyte membrane. Moreover, by selecting the above type of the second solvent, the second solvent is effectively removed during the heat treatment without affecting the structure of the solid-state electrolyte membrane.

In an embodiment of the present disclosure, the above first binder and the second binder are each independently selected from any one or more of poly(vinyl alcohol), poly(tetrafluoroethylene), sodium carboxymethyl cellulose, polyolefine, styrene butadiene rubber, fluorinated rubber, polyurethane, poly(tetrafluoroethylene), polyvinylidene fluoride, and polyethylene oxide; and/or the first solvent and the second solvent each independently selected from any one or more of N-methyl-2-pyrrolidone, toluene, xylene, acetonitrile, chloroform, tetrahydrofuran, water, butyl butyrate, ethylene carbonate, diethyl carbonate, dimethyl carbonate, and ethyl methyl carbonate.

The first binder and the second binder are selected as the above types, such that a binding force between solid-state electrolyte particles and the high molecular polymer base membrane is improved. The first solvent and the second solvent are selected as the above types, such that an effect of dispersing the solid-state electrolyte and the binder is achieved during slurry preparation, so as to coat the first slurry and the second slurry on the high molecular polymer base membrane.

In an embodiment of the present disclosure, the process of the above heat treatment is to dry the wet membrane first and then perform heat pressing.

The presence of the solvent may reduce the mechanical strength and electrical performance of the solid-state electrolyte membrane. Drying is mainly intended to remove the solvent introduced in S1. A specific drying temperature is determined according to a type of the solvent used, so as to effectively remove the solvent in the wet membrane.

In an embodiment of the present disclosure, a drying temperature is 60 °C-100 °C, and a drying time is 6 h-36 h; and/or the heat pressing temperature is 80 °C-250 °C, a heat pressing pressure is 1 MPa-30 MPa, and a heat pressing time is 1 min-120 min.

In an aspect, the controlling of the above drying temperature and time is to effectively remove the solvent introduced during slurry preparation, such that the structure stability of the obtained solid-state electrolyte membrane is improved, and the risk of deformation or damage to the structure of the solid-state electrolyte membrane caused by residual solvents is reduced. In another aspect, controlling the above drying temperature and time, helps to reduce the risk that excessive heat treatment at high temperatures may cause the solid electrolyte to denature and affect its ionic conductivity. The drying temperature may be 60 °C, 65 °C, 70 °C, 75 °C, 80 °C, 85 °C, 90 °C, 95 °C, 100 °C. Definitely, the drying temperature may also be any one of point values within 60 °C-100 °C, and is not described herein again. The drying time may be 6 h, 6.5 h, 7 h, 7.5 h, 8 h, 8.5 h, 9 h, 9.5 h, 10 h, 10.5 h, 11 h, 11.5 h, 15 h, 20 h, 25 h, 30 h, 32 h, or 36 h. Definitely, the drying time may also be any one of point values within 6 h-36 h, and is not described herein again. The heat pressing temperature may be 80 °C, 90 °C, 100 °C, 110 °C, 120 °C, 130 °C, 140 °C, 150 °C, 160 °C, 170 °C, 180 °C, 190 °C, 200 °C, 210 °C, 220 °C, 230 °C, 240 °C, or 250 °C. Definitely, the heat pressing temperature may also be any one of point values within 80 °C-250 °C, and is not described herein again. The heat pressing pressure may be 1 MPa, 5 MPa, 10 MPa, 15 MPa, 20 MPa, 25 MPa, or 30 MPa. Definitely, the heat pressing pressure may also be any one of point values within 1 MPa-30 MPa, and is not described herein again. The heat pressing time may be 1 min, 5 min, 10 min, 15 min, 20 min, 25 min, 30 min, 35 min, 40 min, 45 min, 50 min, 55 min, 60 min, 80 min, 100 min, 110 min, or 120 min. Definitely, the heat pressing time may also be any one of point values within 1 min-120 min, and is not described herein again.

The selection of the heat pressing temperature ensures that hot melt occurs in the high molecular polymer base membrane, but the first solid-state electrolyte and the second solid-state electrolyte are not thermally melted. This causes the high molecular polymer base membrane with a low melting point to be able to melt and cause the high molecular polymer to flow and be filled in the first solid-state electrolyte layer and/or the second solid-state electrolyte layer, such that the close contact between the first solid-state electrolyte layer and the second solid-state electrolyte layer is improved, the mechanical strength of the solid-state electrolyte membrane is improved, the puncture resistance of the solid-state electrolyte membrane is improved, and the impedance of the interface of “the first solid-state electrolyte layer—the high molecular polymer layer—the second solid-state electrolyte layer” is significantly reduced. Moreover, a continuous ion conduction network is formed, and the ionic conductivity of the solid-state electrolyte membrane is improved. The selection of the above heat pressing temperature facilitates a closer contact between the first solid-state electrolyte layer and the second solid-state electrolyte layer during heat pressing, such that interface impedance is reduced, and the transmission efficiency of the lithium ions in the membrane is improved. Through the selection of the above heat pressing pressure and heat pressing time, the microstructure of the solid-state electrolyte membrane is optimized, including more uniform distribution of particles, and improvement of the compactness of the solid-state electrolyte membrane, and these all facilitate improvement of the overall performance of the solid-state electrolyte. Furthermore, an operation mode of heat pressing is selected from any one or more of a flat-bed integral heat pressing mode, an airbag type heat pressing mode, and a plate heat pressing mode.

The above heat treatment process ensures that the solid-state electrolyte membrane has enough mechanical strength to adapt to various pressure conditions during battery manufacturing, and also ensures that the solid-state electrolyte membrane has low interface impedance and high ionic conductivity, thereby significantly improving the charging and discharging efficiency and cycling performance of the battery.

In an embodiment of the present disclosure, average particle sizes of the first solid-state electrolyte in the above first solid-state electrolyte layer and the second solid-state electrolyte in the second solid-state electrolyte layer both are 500 nm-20 μm.

The appropriate average particle sizes of the first solid-state electrolyte and second solid-state electrolyte facilitate formation of continuous and stable lithium ion conduction paths, such that the ionic conductivity of the solid-state electrolyte membrane is improved, thereby improving the charging and discharging performance of the battery. The average particle sizes of the above first solid-state electrolyte and second solid-state electrolyte, in an aspect, facilitate a close contact between the first solid-state electrolyte layer and the second solid-state electrolyte layer, such that impedance at an interface is reduced, and efficient ion transmission is ensured, thereby increasing the energy density of the battery. In another aspect, during a coating process, particles of 500 nm-20 μm easily form a uniform coating, such that the risk of the performance consistency of the battery affected by non-uniform distribution due to excessively-large particles is reduced. Furthermore, in the heat treatment stage, the appropriate average particle sizes of the first solid-state electrolyte and second solid-state electrolyte facilitate uniform heating, such that the controllability of melting and filling processes is improved, and the risk of excessive flow caused by incomplete or insufficient melting due to excessively-large particles is reduced. The average particle sizes of the above first solid-state electrolyte and second solid-state electrolyte may be each independently 500 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm. Definitely, the average particle sizes of the first solid-state electrolyte and second solid-state electrolyte may be each independently any value within 500 nm-20 μm, and is not described herein again.

In an embodiment of the present disclosure, the above mixing operation in S1 further includes: first stirring is performed on the first solid-state electrolyte, the first binder, and the first solvent; and the mixing operation in S2 further includes: second stirring is performed on the second solid-state electrolyte, the second binder, and the second solvent. Rotary speeds of first stirring and second stirring are each independently controlled to be 1000 r/min-1800 r/min, and the time for first stirring and second stirring is independently 0.2 h-1 h, respectively.

In an aspect, the above set stirring rotary speed and time facilitate full dispersion of the first binder (second binder), first solvent (second solvent), and first solid-state electrolyte (second solid-state electrolyte), so as to form the uniform first slurry (second slurry). This step is crucial for the uniformity of subsequent coating and the microstructure of the solid-state electrolyte membrane. If the stirring rotary speed is insufficient, agglomeration of solid-state electrolyte powder in the slurry may be caused, affecting the consistency of the coating and the performance of the membrane. In another aspect, the above stirring rotary speed and time facilitate the refining of the solid-state electrolyte particles, causing the particles to be more uniform and have decreased particle sizes, such that the particles during the heat treatment are better filled in the porous structure of the high molecular polymer base membrane, thereby improving the mechanical strength and conductivity of the solid-state electrolyte membrane. If the stirring time is sufficient, the time for contacting and mixing slurry components may be fully prolonged, so as to form a stable complex structure. When the solid-state electrolyte layer is in contact with the high molecular polymer base membrane or another solid-state electrolyte layer, such stable complex structure may reduce the impedance at an interface, thereby improving the transmission efficiency of lithium ions.

The rotary speeds for the above first stirring and second stirring each may be independently 1000 r/min, 1100 r/min, 1200 r/min, 1300 r/min, 1400 r/min, 1500 r/min, 1600 r/min, 1700 r/min, or 1800 r/min, and definitely, the rotary speeds for the above first stirring and second stirring each may be independently any one of point values within 1000 r/min-1800 r/min, and are not described herein again. The time for the first stirring and second stirring each may be independently 0.2 h, 0.3 h, 0.4 h, 0.5 h, 0.6 h, 0.7 h, 0.8 h, 0.9 h, or 1 h, and definitely, the time for the first stirring and second stirring each may be independently any one of point values within 0.2 h-1 h, and are not described herein again.

Furthermore, the appropriate stirring speed and time can effectively remove air bubbles in the slurry, reduce the defects in the solid-state electrolyte membrane, and ensure the compactness and consistency of the solid-state electrolyte membrane, which have a direct impact on the performance and service life of a battery.

As an implementation, during slurry preparation in S1, the first binder (second binder) and the first solvent (second solvent) are added to a slurry preparation tank together, the first binder (second binder) and the first solvent (second solvent) are uniformly dispersed first, then the first solid-state electrolyte (second solid-state electrolyte) is added to the slurry preparation tank, and the mixture is stirred for uniform dispersion to a maximum extent, so as to obtain the uniform first slurry and second slurry, respectively. As an implementation, in the slurry preparation process of S1, a single material addition time does not exceed 3 min, and the number of times for material addition is 3-10.

The present disclosure is further described in detail below with reference to specific embodiments, and the embodiments cannot be construed as limiting the scope of protection claimed in the present disclosure.

### Embodiment 1

At S1, slurry preparation: 9.8 g of a first solid-state electrolyte Li₆PS₅Cl, 0.2 g of a Styrene Butadiene Rubber binder (SBR binder), and 15.0 g of a toluene solvent were mixed and then stirred, a stirring rotary speed was 1500 r/min, a stirring time was 30 min, and a first slurry was obtained; and 9.8 g of a second solid-state electrolyte Li-La₃Zr₂O₁₂, 0.2 g of an acrylonitrile-butadiene rubber binder (NBR binder), and 15.0 g of the toluene solvent were mixed and then stirred, a stirring rotary speed was 1500 r/min, a stirring time was 30 min, and a second slurry was obtained.

At S2, coating: a PE high molecular polymer base membrane was placed in a mechanical punching device, a pore diameter of the holes in the PE high molecular polymer base membrane was 150 μm, a gap between the holes was 10 μm, and the punched membrane was dried for 4-6 h at 60 °C by being placed in an oven in a glove box or a vacuum oven; then a 100 μm scraper was used to respectively coat the first slurry and the second slurry on two opposite surfaces in a thickness direction of the base membrane, and partial evaporation of a solvent was waited in a room temperature state, so as to obtain a wet membrane having a first solid-state electrolyte layer and a second solid-state electrolyte layer, where a thickness of the PE high molecular polymer base membrane was 5 μm, and a melting point was 130 °C; a thickness of the coated first solid-state electrolyte layer was 50 μm, and a melting point was 450 °C; and a thickness of the coated second solid-state electrolyte layer was 50 μm, and a melting point was 1200 °C.

At S3, heat treatment: the wet membrane was transferred to the vacuum oven for drying, so as to obtain a dry membrane, a drying temperature was 60 °C, a drying time was 12 h, solvents in the first slurry and the second slurry were all completely removed; the dry membrane after drying was cut into a fixed size; a heat treatment was performed on the dry membrane for 20 min at 150 °C and 20 MPa after complete sealing, so as to obtain a solid-state electrolyte membrane; the solid-state electrolyte membrane included a first solid-state electrolyte layer, a high molecular polymer layer, and a second solid-state electrolyte layer, which are sequentially stacked from top to bottom in a thickness direction of the solid-state electrolyte membrane; a thickness of a PE high molecular polymer layer in the solid-state electrolyte membrane after heat pressing was 3 μm, a thickness of the first solid-state electrolyte layer was 24 μm, a thickness of the second solid-state electrolyte layer was 24 μm, a compression ratio was 50%, and a thickness of the final solid-state electrolyte membrane was 51 μm; and the high molecular polymer accounting for 40 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 1:9.

### Embodiment 2

Difference between Embodiment 2 and Embodiment 1 lied in that, in S2, the pore diameter of the holes in the PE high molecular polymer base membrane was 65 μm, the gap between the holes was 15 μm, the thickness of the coated second solid-state electrolyte layer was 100 μm, and the thickness of the final solid-state electrolyte membrane was 60 μm; and the high molecular polymer accounting for 60 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 3:7.

### Embodiment 3

Difference between Embodiment 3 and Embodiment 1 lied in that, in S2, the pore diameter of the holes in the PE high molecular polymer base membrane was 130 μm, the gap between the holes was 20 μm, the thickness of the coated second solid-state electrolyte layer was 100 μm, and the thickness of the final solid-state electrolyte membrane was 60 μm; and the high molecular polymer accounting for 80 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 4:6.

### Embodiment 4

Difference between Embodiment 4 and Embodiment 1 lied in that, in S2, the pore diameter of the holes in the PE high molecular polymer base membrane was 90 μm, the gap between the holes was 25 μm, the thickness of the coated second solid-state electrolyte layer was 100 μm, and the thickness of the final solid-state electrolyte membrane was 60 μm; and the high molecular polymer accounting for 99 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 1:1.

### Embodiment 5

Difference between Embodiment 5 and Embodiment 1 lied in that, in S2, the pore diameter of the holes in the PE high molecular polymer base membrane was 45 μm, the gap between the holes was 100 μm, and the thickness of the coated second solid-state electrolyte layer was 100 μm; in S3, the thickness of the final solid-state electrolyte membrane was 60 μm; and the high molecular polymer accounting for 50 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 2:8.

### Embodiment 6

Difference between Embodiment 6 and Embodiment 1 lied in that, in S1, the first solid-state electrolyte was Li_{0.33}La_{0.56}TiO₃, with a melting point >1200 °C; a mass ratio of the Li_{0.33}La_{0.56}TiO₃ to the first solvent (toluene) was 1:9; the second solid-state electrolyte was Li_{6.25}Al_{0.25}La₃Zr₂O₁₂, a mass ratio of the Li_{6.25}Al_{0.25}La₃Zr₂O₁₂ to the second solvent (toluene) was 1:9, and a melting point was about 1500 °C; in S2, a polycarbonate base membrane was used as the high molecular polymer base membrane, a thickness of the base membrane was 18 μm, and a melting point was about 220 °C-230 °C; and in S3, the heat treatment was performed on the dry membrane for 20 min at 250 °C and 20 MPa, so as to obtain the solid-state electrolyte membrane, a thickness of the polycarbonate base membrane in the solid-state electrolyte membrane after heat pressing was 12 μm, and the mass ratio of the high molecular polymer filled in the first solid-state electrolyte layer to the high molecular polymer filled in the second solid-state electrolyte layer was 1:9.

### Embodiment 7

Difference between Embodiment 7 and Embodiment 1 lied in that, in S1, the first solid-state electrolyte was Li_{6.25}Al_{0.25}La₃Zr₂O₁₂, with a melting point >1000 °C; a mass ratio of the Li_{6.25}Al_{0.25}La₃Zr₂O₁₂ to the first solvent (toluene) was 4:6; the second solid-state electrolyte was Li₁₀GeP₂S12, a mass ratio of the Li₁₀GeP₂S12 to the second solvent (toluene) was 4:6, and a melting point was about 1080 °C; in S2, a polypropylene base membrane was used as the high molecular polymer base membrane, a thickness of the base membrane was 18 μm, and a melting point was about 165 °C-175 °C; and in S3, the heat treatment was performed on the dry membrane for 20 min at 180 °C and 20 MPa, so as to obtain the solid-state electrolyte membrane, a thickness of the polypropylene base membrane in the solid-state electrolyte membrane after heat pressing was 12 μm, and the mass ratio of the high molecular polymer filled in the first solid-state electrolyte layer to the high molecular polymer filled in the second solid-state electrolyte layer was 1:9.

### Embodiment 8

Difference between Embodiment 8 and Embodiment 1 lied in that, in S2, polyvinyl chloride was used as the high molecular polymer base membrane, with a melting point being 170 °C-195 °C; and in S3, the heat treatment was performed on the dry membrane for 20 min at 200 °C and 20 MPa, so as to obtain the solid-state electrolyte membrane, and the mass ratio of the high molecular polymer filled in the first solid-state electrolyte layer to the high molecular polymer filled in the second solid-state electrolyte layer was 1:9.

### Embodiment 9

Difference between Embodiment 9 and Embodiment 1 lied in that, in S2, polystyrene was used as the high molecular polymer base membrane, with a melting point being 212 °C-240 °C; and in S3, the heat treatment was performed on the dry membrane for 20 min at 245 °C and 20 MPa, so as to obtain the solid-state electrolyte membrane, and the mass ratio of the high molecular polymer filled in the first solid-state electrolyte layer to the high molecular polymer filled in the second solid-state electrolyte layer was 1:9.

### Embodiment 10

Difference between Embodiment 10 and Embodiment 1 lied in that, in S2, the thickness of the base membrane in the wet membrane was 18 μm; in S3, the heat treatment was performed on the dry membrane for 20 min at 150 °C and 20 MPa after complete sealing, so as to obtain the solid-state electrolyte membrane; the thickness of the PE high molecular polymer layer in the solid-state electrolyte membrane was 12 μm, and the thickness of the final solid-state electrolyte membrane was 55 μm; and the high molecular polymer accounting for 35 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 1:9.

### Embodiment 11

Difference between Embodiment 11 and Embodiment 1 lied in that, in S2, the thickness of the base membrane in the wet membrane was 18 μm; in S3, the heat treatment was performed on the dry membrane for 20 min at 150 °C and 20 MPa after complete sealing, so as to obtain the solid-state electrolyte membrane; the thickness of the PE high molecular polymer layer in the solid-state electrolyte membrane was 12 μm, and the thickness of the final solid-state electrolyte membrane was 60 μm; and the high molecular polymer accounting for 50 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 3:7.

### Embodiment 12

Difference between Embodiment 12 and Embodiment 1 lied in that, in S2, the thickness of the base membrane in the wet membrane was 18 μm; in S3, the heat treatment was performed on the dry membrane for 20 min at 150 °C and 20 MPa after complete sealing, so as to obtain the solid-state electrolyte membrane; the thickness of the PE high molecular polymer layer in the solid-state electrolyte membrane was 12 μm, and the thickness of the final solid-state electrolyte membrane was 25 μm; and the high molecular polymer accounting for 30 wt % of the total mass of the high molecular polymer layer was filled in the first solid-state electrolyte layer and the second solid-state electrolyte layer, and a mass ratio of the high molecular polymer filled in the first solid-state electrolyte layer to the high molecular polymer filled in the second solid-state electrolyte layer was 1:9.

### Embodiment 13

Difference between Embodiment 13 and Embodiment 1 lied in that, the solid-state electrolyte membrane included the second solid-state electrolyte layer, the high molecular polymer layer, and the first solid-state electrolyte layer, which are sequentially stacked from top to bottom in the thickness direction of the solid-state electrolyte membrane; and the mass ratio of the high molecular polymer filled in the first solid-state electrolyte layer to the high molecular polymer filled in the second solid-state electrolyte layer was 9:1.

### Embodiment 14

Difference between Embodiment 14 and Embodiment 1 lied in that, in S2, the pore diameter of the holes in the PE high molecular polymer base membrane was 160 μm, the gap between the holes was 30 μm, and the mass ratio of the high molecular polymer filled in the first solid-state electrolyte layer to the high molecular polymer filled in the second solid-state electrolyte layer was 0.

### Comparative Embodiment 1

A difference between Comparative embodiment 1 and Embodiment 1 lied in that, in S3, the heat pressing treatment was not performed, and the solid-state electrolyte membrane was finally obtained.

### Comparative Embodiment 2

A difference between Comparative embodiment 2 and Embodiment 1 lied in that, in S3, the temperature for the heat pressing treatment was 30 °C, and the solid-state electrolyte membrane was finally obtained.

### Comparative Embodiment 3

A difference between Comparative embodiment 3 and Embodiment 1 lied in that, in S1, there were no pores in the PE base membrane, that is, the porosity was 0, and the solid-state electrolyte membrane was finally obtained.

### Performance Test:

Mechanical strength of solid-state electrolyte membrane: its tensile strength was tested by using the ASTM D882 standard.

Ionic conductivity of solid-state electrolyte membrane: its ionic conductivity was calculated by using a formula L/RS, where L represented a diaphragm thickness (cm), R represented Ohmic impedance (Ω), and S represented a diaphragm area (cm²).

Impedance of solid-state electrolyte membrane: a steel plate was clamped on both sides of the diaphragm, and impedance was tested on an electrochemical workstation.

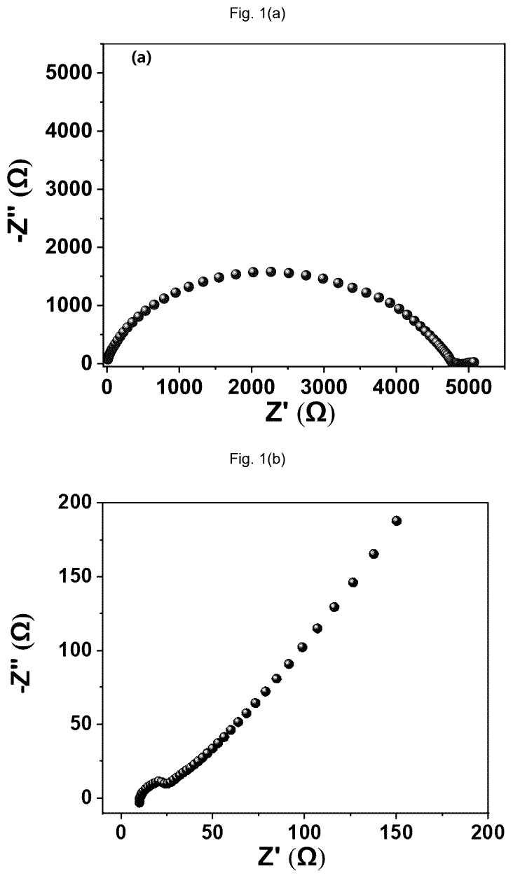

The solid-state electrolyte membranes in the above embodiments and comparative embodiments were assembled into lithium ion solid-state batteries respectively with an NCM811 cathode and a graphite anode. Within a frequency range of 1 MHz-0.1 Hz, an Electrochemical Impedance Spectroscopy (EIS) test was performed on an amplitude of an alternating-current voltage at 5 mV. FIG. 1(a) was an EIS diagram of a solid-state battery corresponding to the solid-state electrolyte membrane without heat pressing in Comparative embodiment 1. FIG. 1(b) was an EIS test diagram of the solid-state battery corresponding to the solid-state electrolyte membrane after heat pressing in Embodiment 1.

According to test results in the figures, it might be seen that an impedance value significantly reduced after heat pressing, and if the impedance value is smaller, the charging and discharging efficiency of a battery is higher.

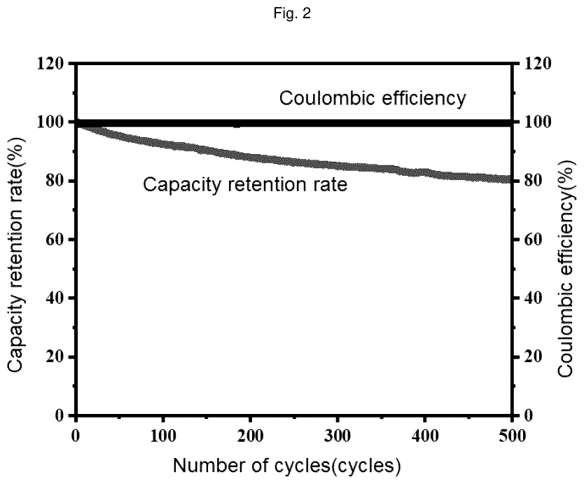

FIG. 2 was a test diagram of cycling performance of a full battery of the solid-state electrolyte membrane shown in Embodiment 1 of the present disclosure. From FIG. 2, it might be seen that the battery using the solid-state electrolyte membrane had a charging and discharging capability at a high rate, a battery constant current at a rate of 1 C was charged to 4.25 V, a constant current was discharged to 2.5 V, and a capacity retention rate for 500 cycles remained at 81.56%.

The capacity retention rate for 500 cycles at the rate of 1 C and energy density of the lithium ion solid-state battery obtained in the above embodiments and comparative embodiments were tested, and all the above test results were listed in Table 1.

TABLE 1

| | | | | Capacity | |
|---|---|---|---|---|---|
| | | | | retention | |
| | | | | rate (%) | Energy |
| | Mechanical | Ionic | | of lithium | density |
| | strength | conductivity | Impedance | ion | (Wh/kg) |
| | (MPa) of | (S/cm) of | (Ω) of | solid-state | of lithium |
| Embodiment/ | solid-state | solid-state | solid-state | battery | ion |
| comparative | electrolyte | electrolyte | electrolyte | for 500 | solid-state |
| embodiment | membrane | membrane | membrane | cycles | battery |
| Embodiment 1 | 13 | 7.14 × 10⁻⁴ | 86 | 81.56 | 348 |
| Embodiment 2 | 20 | 6.17 × 10⁻⁴ | 133 | 76.84 | 312 |
| Embodiment 3 | 18 | 6.52 × 10⁻⁴ | 94 | 80.03 | 345 |
| Embodiment 4 | 19 | 6.34 × 10⁻⁴ | 111 | 78.97 | 323 |
| Embodiment 5 | 23 | 5.89 × 10⁻⁴ | 202 | 75.32 | 287 |
| Embodiment 6 | 19 | 1.13 × 10⁻³ | 475 | 70.69 | 316 |
| Embodiment 7 | 21 | 1.32 × 10⁻³ | 435 | 72.19 | 323 |
| Embodiment 8 | 18 | 1.51 × 10⁻³ | 497 | 70.25 | 307 |
| Embodiment 9 | 17 | 1.85 × 10⁻³ | 380 | 73.62 | 319 |
| Embodiment 10 | 18 | 7.68 × 10⁻⁴ | 223 | 74.93 | 305 |
| Embodiment 11 | 20 | 7.98 × 10⁻⁴ | 242 | 74.36 | 296 |
| Embodiment 12 | 12 | 5.43 × 10⁻⁴ | 116 | 77.85 | 324 |
| Embodiment 13 | 24 | 7.95 × 10⁻⁴ | 120 | 76.98 | 332 |
| Embodiment 14 | 10 | 1.22 × 10⁻³ | 56 | 83.62 | 328 |
| Comparative | 5 | 2.13 × 10⁻⁵ | 1051 | 67.93 | 215 |
| embodiment 1 | | | | | |
| Comparative | 15 | 3.15 × 10⁻⁴ | 857 | 69.54 | 227 |
| embodiment 2 | | | | | |
| Comparative | 25 | 5.18 × 10⁻⁵ | 2600 | 65.09 | 165 |
| embodiment 3 | | | | | |

It might be seen from the above description that, in the above embodiments of the present disclosure, the following technical effects were realized.

In the technical solutions of the present disclosure, in an aspect, the high molecular polymer in at least the portion of the high molecular polymer layer in the solid-state electrolyte membrane is filled in the first solid-state electrolyte layer and/or the second solid-state electrolyte layer. Such structure can effectively reduce physical isolation of a base membrane (high molecular polymer layer)-solid-state electrolyte interface, promote smooth transmission of ions, and therefore, significantly reduce the impedance of an interface of “first solid-state electrolyte layer—high molecular polymer layer—second solid-state electrolyte layer”. Low interface impedance means that a charge carrier can move between cathode and anode more efficiently, thereby improving the overall electrochemical performance such as cycling stability and the like of a battery. In another aspect, since low interface impedance allows a faster ion transmission speed, the rational design of the high molecular polymer layer also facilitates improvement of the charging and discharging performance of the battery. In combination with the above two aspects, in the present disclosure, through the unique structure design of the solid-state electrolyte membrane, the solid-state electrolyte membrane of the present disclosure has a good external shape, and causes the solid-state battery to have excellent interface compatibility, mechanical strength, capacity, energy density, charging and discharging performance, and cycle life.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

What is claimed is:

1. A solid-state electrolyte membrane, comprising a first solid-state electrolyte layer, a high molecular polymer layer, and a second solid-state electrolyte layer, which are sequentially stacked in a thickness direction of the solid-state electrolyte membrane, wherein at least a portion of high molecular polymer in the high molecular polymer layer is filled in the first solid-state electrolyte layer and/or the second solid-state electrolyte layer.

2. The solid-state electrolyte membrane according to claim 1, wherein 30 wt %-99 wt % of the high molecular polymer of the high molecular polymer layer is filled in the first solid-state electrolyte layer and/or the second solid-state electrolyte layer.

3. The solid-state electrolyte membrane according to claim 1, wherein when the high molecular polymer is filled in the first solid-state electrolyte layer and the second solid-state electrolyte layer at the same time, a mass ratio of the high molecular polymer filled in the first solid-state electrolyte layer to the high molecular polymer filled in the second solid-state electrolyte layer is 1-99:99-1.

4. The solid-state electrolyte membrane according to claim 1, wherein mechanical strength of the solid-state electrolyte membrane is 8 MPa-35 MPa; and/or ionic conductivity of the solid-state electrolyte membrane is 0.5×10⁻⁵ S/cm-9.0×10⁻³ S/cm; and/or impedance of the solid-state electrolyte membrane is 15Ω-1200Ω.

5. The solid-state electrolyte membrane according to claim 1, wherein a melting point of a first solid-state electrolyte in the first solid-state electrolyte layer and a melting point of a second solid-state electrolyte in the second solid-state electrolyte layer both are higher than a melting point of the high molecular polymer.

6. The solid-state electrolyte membrane according to claim 1, wherein a melting point of the high molecular polymer is 80 °C-600 °C.

7. The solid-state electrolyte membrane according to claim 1, wherein a thickness of the solid-state electrolyte membrane is 20 μm-60 μm.

8. The solid-state electrolyte membrane according to claim 1, wherein the high molecular polymer is derived from any one or more of a polyethylene base membrane, a polypropylene base membrane, a polyvinyl chloride base membrane, a polystyrene base membrane, a polyoxymethylene base membrane, a polycarbonate base membrane, a polyamide base membrane, a polyacrylic acid copolymer base membrane, a polysulfone base membrane, a polyphenyl ether base membrane, a polyetherchloride base membrane, and an aramid base membrane.

9. The solid-state electrolyte membrane according to claim 1, wherein a melting point of a first solid-state electrolyte in the first solid-state electrolyte layer is 300 °C-1300 °C.

10. The solid-state electrolyte membrane according to claim 1, wherein a thickness of the first solid-state electrolyte layer is 10 μm-60 μm.

11. The solid-state electrolyte membrane according to claim 1, wherein a first solid-state electrolyte in the first solid-state electrolyte layer and a second solid-state electrolyte in the second solid-state electrolyte layer are each independently selected from any one or more of a sulfide solid-state electrolyte, an oxide solid-state electrolyte, and a polymer solid-state electrolyte.

12. The solid-state electrolyte membrane according to claim 11, wherein the first solid-state electrolyte and the second solid-state electrolyte are each independently selected from any one or more of Li_{0.33}La_{0.56}TiO₃, Li_{6.25}Al_{0.25}La₃Zr₂O₁₂, Li₁₀GeP₂S12, Li₂S, Li₃PS₄, Li₂P₃S11, Li₆PS₅Cl, ZrO₂, Li₇La₃Zr₂O₁₂, Li_{1.3}Al_{0.3} Ti_{1.7} (PO₄)₃, LLTO, and a PEEK-LLZO composite material.

13. The solid-state electrolyte membrane according to claim 1, wherein a melting point of a second solid-state electrolyte in the second solid-state electrolyte layer is 300 °C-1300 °C.

14. The solid-state electrolyte membrane according to claim 1, wherein a thickness of the second solid-state electrolyte layer is 10 μm-60 μm.

15. A method for preparing the solid-state electrolyte membrane according to claim 1, wherein the preparation method comprises:
S1, mixing a first solid-state electrolyte, a first binder, and a first solvent to obtain a first slurry; and mixing a second solid-state electrolyte, a second binder, and a second solvent to obtain a second slurry;
S2, respectively coating the first slurry and the second slurry on two opposite surfaces in a thickness direction of a high molecular polymer base membrane, so as to obtain a wet membrane; and
S3, performing a heat treatment on the wet membrane to obtain a solid-state electrolyte membrane, wherein
the heat treatment comprises heat pressing, and a heat pressing temperature is higher than a melting-point temperature of the high molecular polymer base membrane, and is lower than a melting-point temperature of the first solid-state electrolyte and a melting-point temperature of the second solid-state electrolyte.

16. The preparation method according to claim 15, wherein a mass ratio of the first solid-state electrolyte to the first binder is (4:1)-(49:1), and/or a mass ratio of the first solid-state electrolyte to the first solvent is (1:9)-(4:6).

17. The preparation method according to claim 15, wherein a mass ratio of the second solid-state electrolyte to the second binder is (49:1)-(4:1), and/or a mass ratio of the second solid-state electrolyte to the second solvent is (1:9)-(4:6).

18. The preparation method according to claim 15, wherein the first binder and the second binder are each independently selected from any one or more of poly(vinyl alcohol), poly(tetrafluoroethylene), sodium carboxymethyl cellulose, polyolefine, styrene butadiene rubber, fluorinated rubber, polyurethane, poly(tetrafluoroethylene), polyvinylidene fluoride, and polyethylene oxide; and/or the first solvent and the second solvent each independently selected from any one or more of N-methyl-2-pyrrolidone, toluene, xylene, acetonitrile, chloroform, tetrahydrofuran, water, butyl butyrate, ethylene carbonate, diethyl carbonate, dimethyl carbonate, and ethyl methyl carbonate.

19. The preparation method according to claim 15, wherein the process of the heat treatment is to dry the wet membrane first and then perform heat pressing.

20. The preparation method according to claim 19, wherein a drying temperature is 60 °C-100 °C, and a drying time is 6 h-36 h; and/or the heat pressing temperature is 80 °C-600 °C, a heat pressing pressure is 1 MPa-30 MPa, and a heat pressing time is 1 min-120 min.
